(19) United States
(12) Patent Application Publication
(10) Pub. No.: US 2007/0203885 A1
(43) Pub. Date: Aug. 30, 2007

(54) Document Classification Method, and Computer Readable Record Medium Having Program for Executing Document Classification Method By Computer

(75) Inventors: Jae-Ho KIM, Daejeon (KR); Key-Sun CHOI, Daejeon (KR)

Correspondence Address: FOLEY AND LARDNER LLP;SUITE 500, 3000 K STREET NW, WASHINGTON, DC, 20007, US

(73) Assignee: Korea Advanced Institute of Science & Technology

(21) Appl. No.: 11/464,073

(22) Filed: Aug. 11, 2006

(30) Foreign Application Priority Data
Feb. 28, 2006 (KR) 10-2006-0019513

(51) Int. Cl. G06F 17/30

(52) U.S. Cl. 707/2

(57) ABSTRACT

Provided are a document classification method and a computer readable record medium having a program for executing the document classification method by a computer. The method for providing a classification code to a document, and classifying the document, includes a document indexing process of re-organizing contents of training documents using structure information of the training documents provided with classification codes, and generating an index list; a document retrieval process of searching the training documents for similar documents similar with an input document, using the index list; and a classification code generating process of generating a classification code list of the input document, using the classification codes of the similar documents.

This Nonprovisional application claims priority under 35 U.S.C. §119(a) on Patent Application No. 10-2006-0019513 filed in Korea on Feb. 28, 2006, the entire contents of which are hereby incorporated by reference.

### BACKGROUND OF THE INVENTION

1. Field of the Invention

The present invention relates to a document classification method, and a computer readable record medium having a program for executing the document classification method by a computer.

2. Description of the Background Art

One document can be expressed by vector together with a weight value on a per-keyword basis, using keywords of a whole document or keywords of a summary of document content.

In conventional document classification methods, a document is classified using machine learning, by a similarity with a keyword vector on a per-classification code basis that is extracted from all documents provided within a training set and provided with a classification code. Alternately, a document is classified by the most similar documents retrieved from a training set through a comparison of a document-document keyword vector.

Unlike a general document, documents such as a patent document are highly structured in its content. Therefore, the utilization of structure information is helpful for automatic classification. However, it is not being well utilized in the conventional methods.

For example, since a Japanese patent document is minutely structured as <Background Art>, <Problem of Background art>, <Construction for Solving Problem>, <Embodiment>, <Effects of Invention>, and <Claims>, the use of such information is greatly helpful for the automatic classification. For example, since the <Background Art> includes a technical field and its related information, it can be more helpful for classification than any other parts. Because the <Problem of Background Art> and <Construction for Solving Problem> being representative of the patent document are mainly used in an abstract of disclosure, they have significant information together with the <Claims>.

Up to now, there is not a method for suitably well utilizing such a structural feature of the patent document.

Thus, a method for suitably utilizing the structural feature of the highly structured document such as the Japanese patent document and effectively classifying the document is being required.

### SUMMARY OF THE INVENTION

Accordingly, the present invention is to solve at least the problems and disadvantages of the background art.

The present invention is to provide a document classification method for automatically providing a classification code to a structured document, and a computer readable record medium having a program for executing the document classification method by a computer.

Also, the present invention is to provide a document classification method for, even though a user does not directly extract keywords from the document, automatically analyzing content of a document itself and classifying the document, and a computer readable record medium having a program for executing the document classification method by a computer,

To achieve these and other advantages and in accordance with the purpose of the present invention, as embodied and broadly described, there is provided a document classification method for providing a classification code to a document, and classifying the document, The method includes a document indexing process of re-organizing contents of training documents using structure information of the training documents provided with classification codes, and generating an index list; a document retrieval process of searching the training documents for similar documents similar with an input document, using the index list; and a classification code generating process of generating a classification code list of the input document, using the classification codes of the similar documents.

The document indexing process may include a training document re-organization process of re-organizing each of the training documents at each of semantic tags of “n” number (“n” is positive integer) reflecting the structure information of the training documents; a training document keyword extracting process of extracting keywords at each document content comprised in the “n” number of semantic tags; and an index list generating process of generating “n” number of index lists corresponding to the “n” number of semantic tags, depending on the keyword.

The “n” may equal to 4 to 8.

The document retrieval process may include an input document re-organizing process of re-organizing content of the input document depending on the “n” number of semantic tags; an input document keyword extracting process of extracting the keywords at each document content comprised in the “n” number of semantic tags; a search query generating process of generating “n” number of search queries corresponding to the “n” number of semantic tags, depending on the keywords; and a similar document list generating process of comparing the “n” number of index lists with the “n” number of search queries, and generating a list of the similar document similar with the input document,

The search query generating process may extend a range of vocabularies comprised in the “n” number of search queries, using a synonym dictionary.

The similar document list generating process may compare the “n” number of index lists with the “n” number of search queries on a per-same semantic tag basis, and generate the list of the similar document similar with the input document,

The similar document list generating process may cross-compare the “n” number of index lists with the “n” number of search queries at each of the “n” number of semantic tags, and may generate the list of the similar document similar with the input document.

The similar document list generating process may provide a weight value proportional to a frequency of use of a vocabulary comprised in the “n” number of search queries, and determine a similarity score and a search rank of the similar document comprised in the similar document list.

The classification code generating process may calculate a score on a per-classification code basis of the input document depending on the similarity score and the search rank of the similar document determined in the similar document list generating process, and generate a classification code list of the input document.

In another aspect of the present invention, there is provided a computer readable record medium for recording a program for executing, by a computer, a document classification method for providing a classification code to a document and classifying the document. The method includes a document indexing process of re-organizing contents of training documents using structure information of the training documents provided with classification codes, and generating an index list; a document retrieval process of searching the training documents for similar documents similar with an input document, using the index list; and a classification code generating process of generating a classification code list of the input document, using the classification codes of the similar documents,

### BRIEF DESCRIPTION OF THE DRAWINGS

The invention will be described in detail with reference to the following drawings in which like numerals refer to like elements.

FIG, 1 illustrates a structure of a Japanese patent document;

FIG. 2 illustrates a document classification method according to an exemplary embodiment of the present invention;

FIG. 3 schematically illustrates a process of indexing a document in a document classification method according to an exemplary embodiment of the present invention;

FIG. 4 illustrates a method for re-organizing a document depending on “n” number (n=6) of semantic tags;

FIG. 5 schematically illustrates a process of searching a document in a document classification method according to an exemplary embodiment of the present invention;

FIG. 6 illustrates a method for comparing a search query of an input document with an index list of training documents on a per-same semantic tag basis, and generating a list of a similar document;

FIG. 7 illustrates a method for cross-comparing a search query of an input document with an index list of training documents on a per-semantic tag basis, and generating a list of a similar document; and

FIG. 8 schematically illustrates a process of generating a classification code in a document classification method according to an exemplary embodiment of the present invention.

### DETAILED DESCRIPTION OF PREFERRED EMBODIMENTS

Preferred embodiments of the present invention will be described in a more detailed manner with reference to the drawings,

The present invention is adapted to classifying a structured document. A highly structured Japanese patent document will be exemplified below.

First, a structure of the Japanese patent document will be described.

FIG. 1 illustrates the structure of the Japanese patent document.

As shown in FIG. 1, the Japanese patent document is comprised of six main categories of <Bibliographic Information> 100, <Abstract> 101, <Claims> 102, <Detailed Description> 103, <Description of Drawings> 104, and <Drawings> 105. The <Abstract> and <Detailed Description> are comprised of segmented categories of <Object> 110, <Problem of Background Art> 111, <Operation> 112, and <Effects of Invention> 113. A title of the main category is fixed, whereas a title of the segmented category is almost fixed but is also defined and used by a user. Thus, various tags are also provided. Actually, as the extraction result, 3,516 tags are extracted from the segmented categories of the <Abstract> and <Detailed Description> of 347,227 1993-year Japanese patent documents. The present invention defines the tags as user-defined tags. In order to use the user-defined tag, it is required to group and reduce the user-defined tags by several numbers as described later.

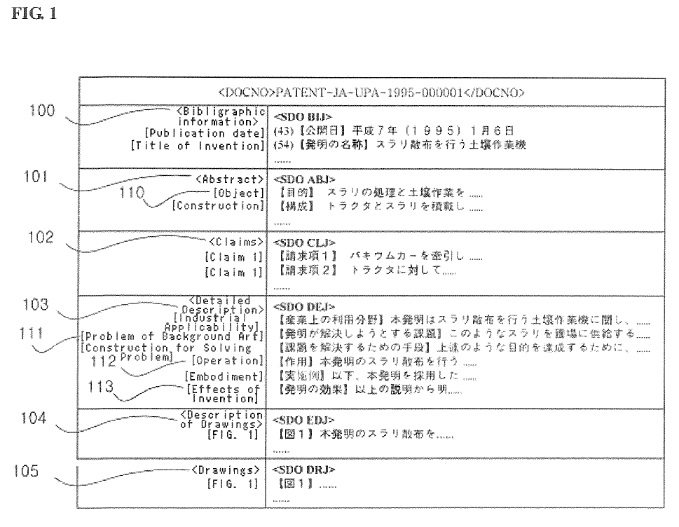

FIG. 2 illustrates a document classification method according to an exemplary embodiment of the present invention.

As shown in FIG. 2, the document classification method for providing a classification code to a document and classifying the document, includes steps of a document indexing step 21 of re-organizing contents of training documents using structure information of the training documents provided with the classification codes, and generating an index list; and a document retrieval step 22 of searching the training documents for similar documents similar with an input document, using the index list; and a classification code generating step 23 for generating a classification code list of the input document using the classification codes of the similar documents.

The document classification method according to an exemplary embodiment of the present invention will be in detail described on a per-step basis below,

<Document Indexing Step 21>

The document indexing step 21 indexes the training documents 301 to search the training documents 301 for the similar document similar with the input document to be classified.

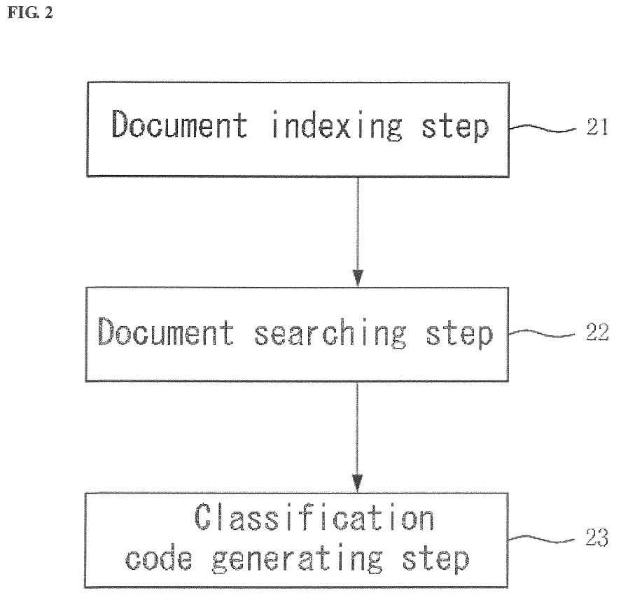

As shown in FIG. 3, the document indexing step 21 preferably includes a training document re-organizing step 302 of re-organizing each of the training documents 301 at each of semantic tags of “n” number (“n” is positive integer) reflecting structure information of the training documents 301; a training document keyword extracting step 304 for extracting keywords from each document content included in the “n” number of semantic tags; and an index list generating step 305 for generating “n” number of index lists 306 corresponding to the “n” number of semantic tags depending on the keywords. For description convenience, a description will be made on the assumption that “n” equals to 6. However, the present invention is not limited in its scope to the assumption that “n” equals to 6.

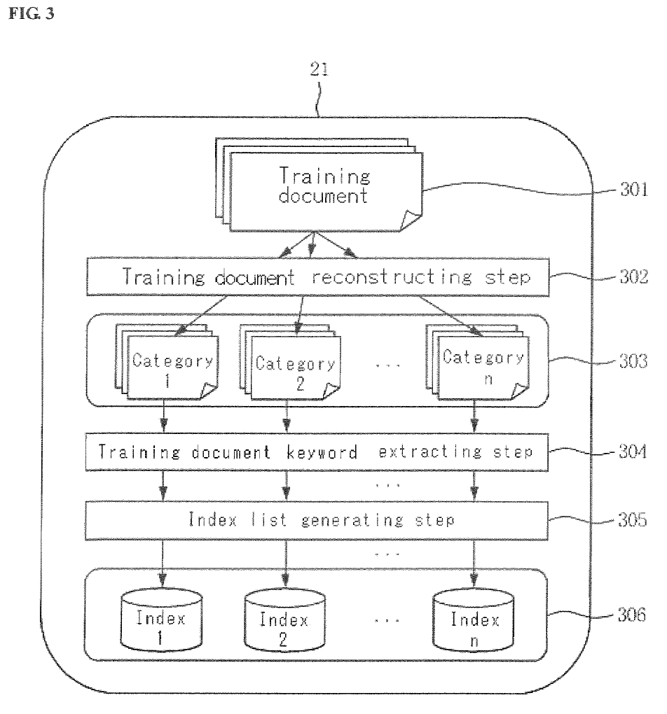

The document indexing step 21 will be in detail described as follows. 1411 First, the training document re-organizing step 302 re-organizes the training documents 301 at each of six semantic tags of <Technical Field>, <Object>, <Solution>, <Claims>, <Description>, and <Example> as predefined in FIG. 4, and divides the training documents 301 into at each of semantic tag categories 303.

Next, the training document keyword extracting step 304 extracts the keywords from each of the semantic tag categories 303.

After that, the index list generating step 305 generates the index list 306 for search, on a per-semantic tag basis.

In the present invention, the training document is re-organized using the user-defined tag represented in the training document. Since the user-defined tags are variously provided as above, the user-defined tags are grouped by the head noun represented in the user-defined tag, and then are used. On the basis of a rule where the last noun of the user-defined tag is the head noun, the head noun is extracted from the user-defined tag, and is sorted by its frequency. For example, one hundred high-frequency head nouns are grouped, by a manual work, among 1,475 head nouns extracted from 3,516 user-defined tags. These head nouns are classified by the six semantic tags of <Technical Field>, <Object>, <Solution>, <Claims>, <Description>, and <Example>, for example.

1,940 user-defined tags are classified by the one hundred head nouns. This is a number corresponding to 99.86% of a whole frequency of the user-defined tag on the basis of accumulation frequency. Therefore, the user-defined tags other than the 1,940 user-defined tags classified by the head nouns are disregarded.

Table 1 shows examples of the user-defined tags classified by the six semantic tags.

TABLE 1

| Semantic tag | Example of user-defined tag |
|---|---|
| Technical Field | [symbol] (Industrial Applicability) |
| | [symbol] (Background Art) |
| | [symbol] (Background of Invention) |
| Object | [symbol] (Title of Invention) |
| | [symbol] (Object of Invention) |
| | [symbol] (Problem of Background Art) |
| Solution | [symbol] |
| | (Construction for Solving Problem) |
| | [symbol] |
| | (Construction and Operation for Solving Problem) |
| Claims | All user tags included in <Patent Claims> category |
| Description | [symbol] (Effects of Invention) |
| | [symbol] |
| | (Construction and Operation for Solving Problem) |
| | [symbol] (Detailed Description of Invention) |
| Example | [symbol] (Exemplary Embodiment), [symbol] (Several |
| | Embodiments), [symbol] (Reference Example), [symbol] |
| | (Experimental Example) |

The user-defined tags connected with each other by a coordinating conjunction, such as a user-defined tag of [symbol] [symbol] [symbol] (Construction and Operation for Solving Problem), can be multi-classified into “Solution” and “Description”. Contents are collected at each of the thus obtained six semantic tags, and the training document is re-organized as described above in FIG. 4. Some portions are deleted, or other portions are duplicated and belong to several parts due to multi-classification.

<Document Retrieval Step 22>

The document retrieval step 22 searches for the similar document similar with the input document to be classified, using the index list 306 generated in the document indexing step 21.

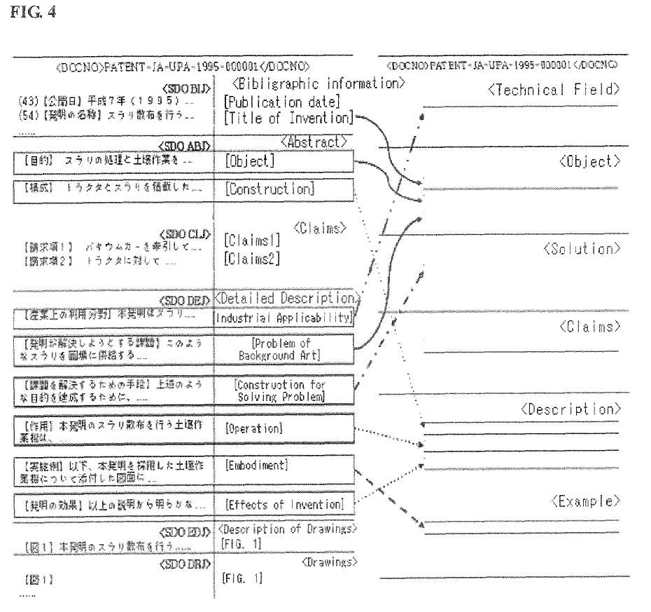

As shown in FIG. 5, the document retrieval step 22 preferably includes an input document re-organizing step 502 of re-organizing the content of the input document 501, depending on the six semantic tags; an input document keyword extracting step 504 of extracting the keyword at each document content included in the six semantic tags; a search query generating step 505 of generating six search queries 506 corresponding to the six semantic tags, depending on the keyword; and a similar document list generating step 508 of comparing the six index lists 306 with the six search queries 506, and generating a list 509 of the similar document similar with the input document 501.

The document retrieval step 22 will be in detail described as follows.

In the same method as that of the training document re-organizing step 302, the input document re-organizing step 502 reconstructs the input document 501 at each of the six semantic tags of <Technical Field>, <Object>, <Solution>, <Claims>, <Description>, and <Example> as predefined in FIG. 4, and divides the input document into at each of semantic tag categories 503.

Next, the input document keyword extracting step 504 extracts the keywords from each of the divided semantic tag categories 503.

After that, the search query generating step 505 generates the six search queries 506 corresponding to the six semantic tags, depending on the keywords.

In the extracted keywords, a range of vocabularies included in the six search queries is extended using a synonym dictionary so as to extend an application range of search, and the six search queries 506 are finally generated.

Next, the similar document list generating step 508 compares the six index lists 306 with the six search queries 506, and generates the list 509 of the similar document similar with the input document 501

The similar document list generating step 508 can compare the six index lists 306 with the six search queries 506 on a per-same semantic tag basis, and generate the list 509 of the similar document similar with the input document 501.

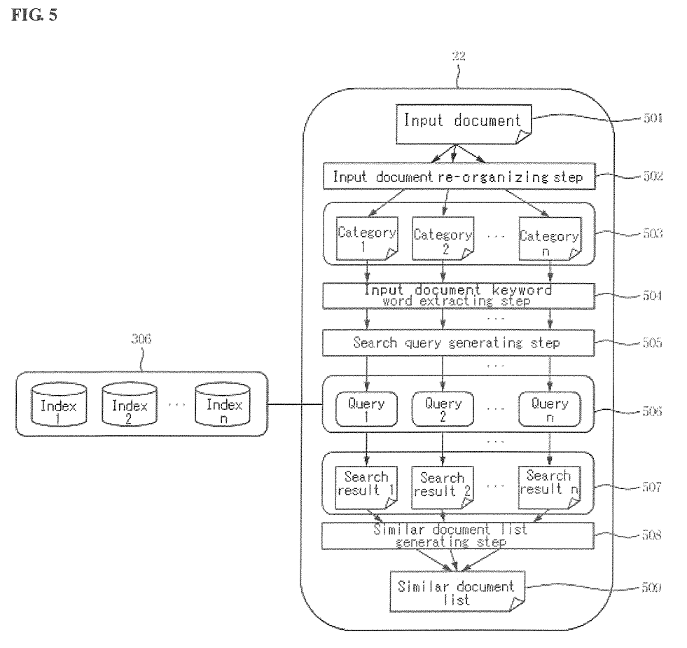

In other words, as shown in FIG. 6, weight values are given and summed up with the six search results, which are obtained by comparing the six search queries 506 with the six index lists 306 on a per-same semantic tag basis, thereby generating a similar document list 509a.

The present invention has a feature of, at the time of searching for the similar document, comparing content on a per-semantic tag basis, not a whole document. This is based on the assumption that the same technical field, and the same background-art problem and the same solution are requisites for the similar document.

However, such an only point-to-point mapping between the same semantic tags can also cause much deterioration in performance for the following reasons.

First, words used in claims to broaden a scope of a patent claim mainly employ obscure and general terms. Thus, a comparison between claim categories can deteriorate reproducibility,

Second, the user-defined tag defined by the user is not reliable by 100%, The user can write “[Problem of Background Art]”, and describe even its solution together.

Third, semantic tag classification according to the inventive method is not reliable by 100%. The user-defined tags are grouped on the basis of the head word, but an error necessarily exists. “Description of Problem” should be classified as “Object”, but is classified as “Description” according to the inventive method.

Accordingly it is desirable that the similar document list generating step cross-compares the six index lists with the six search queries at each of the six semantic tags, and generates the list of the similar document similar with the input document.

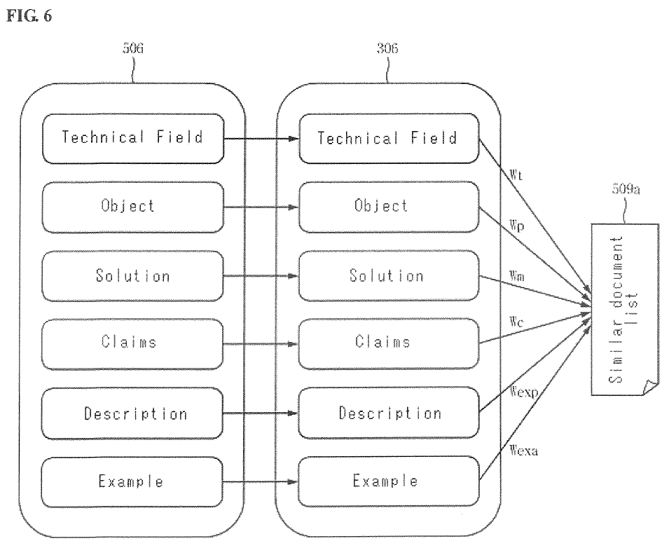

In other words, as shown in FIG. 7, thirty six results obtained from cross-comparison for allowing even a comparison between meaning categories different from each other are summed up, thereby generating the similar document list 509a.

Meantime, it is desirable to provide a weight value proportional to a frequency of use of vocabularies included in the six search queries, and determine a similarity score and a search rank of the similar document included in the similar document list.

Meantime, in order to enhance the accuracy of search, unnecessary words can be removed from the search query. For example, there are [symbol] (thing), [symbol] (invention), [symbol] (object), [symbol] (problem), [symbol] (matter), [symbol] (claim), and [symbol] (description).

<Classification Code Generating Step 23>

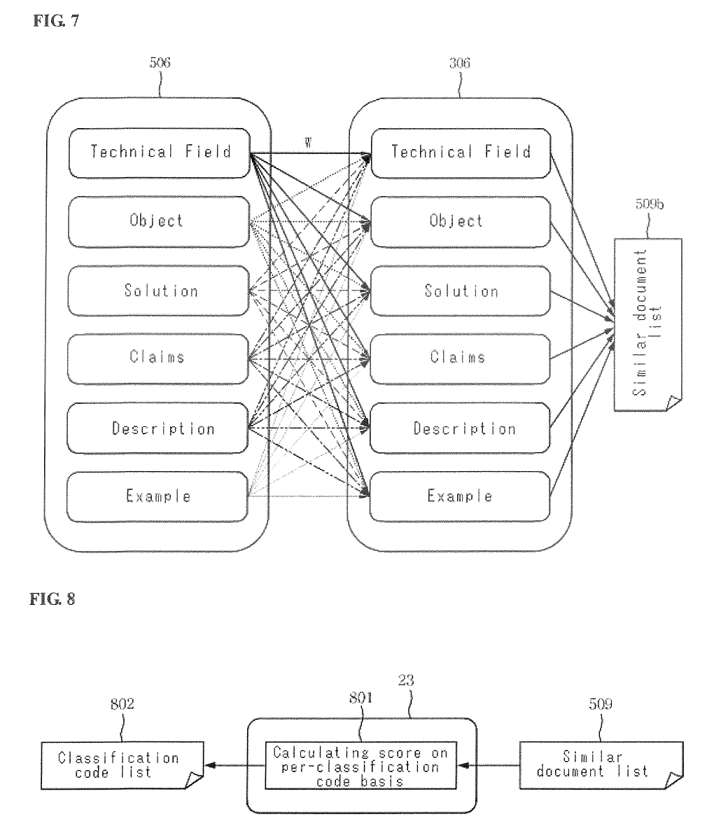

As shown in FIG. 8, the classification code generating step 23 provides a classification code list 802 of the input document using the similar document list 509 generated in the document retrieval step 22.

In its more detailed description, a score on a per-classification code basis of the input document 501 is calculated depending on the search rank and the similarity score of the similar document determined in the similar document list generating step 508 and a classification code list 802 of the input document 501 is generated,

When the score on a per-classification code basis of the input document is calculated, the similarity score and the search rank of the similar document are considered as expressed in Equation:

$${Score}_{category} ( C ) = {\sum }_{\{ d \vert c ∈ categories of doc d \}} {Score}_{doc} ( d ) \times {weight}_{doc} ( d ) \\ {Weight}_{doc} ( d ) = \{ \begin{matrix}1 & rank ( d ) \leq k \\ α & k < rank ( d ) \leq N ( 0 \leq α < 1 )\end{matrix} \qquad [ Equation ]$$

where,

Score_{doc}(d): similarity score of document (d) searched as similar document, and

Rank(d): search rank of document (d) searched as similar document.

The document weight value (weight_{doc}(d)) equals to “1” when the document is within a rank of “k”. The (weight_{doc}(d)) equals to “α” when the document is greater than the rank of “k” and is within a rank of “N“(=200). Values obtained by multiplying the document similarity score by the weight value, are summed up at each of classification codes (c) of the document, and the classification code score (Score_{category}(c)) is calculated. This is ranked to finally provide the classification code list of the input document 501.

As described above, according to the present invention, the document itself is inputted and classified. Therefore, desired information can be easily and quickly searched by one-time execution, without pains such as selecting the search keywords.

Further, classification is performed on the basis of not several keywords of the document but the content of the document and thus, the more accurate classification result can be obtained.

The document classification method according to the present invention can be recorded on the computer readable record medium.

According to the present invention the document itself is inputted and classified. Therefore, desired information can be easily and quickly searched by one-time execution, without pains such as selecting the search keywords.

The classification is performed on the basis of not several keywords of the document but the content of the document and thus, the more accurate classification result can be obtained.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A document classification method for providing a classification code to a document, and classifying the document, the method comprising:
a document indexing step of re-organizing contents of training documents using structure information of the training documents provided with classification codes, and generating an index list;
a document retrieval step of searching the training documents for similar documents similar with an input document, using the index list; and
a classification code generating step of generating a classification code list of the input document, using the classification codes of the similar documents.

2. The method of claim 1, wherein the document indexing step comprises:
a training document re-organizing step of re-organizing each of the training documents at each of semantic tags of “n” number (“n” is positive integer) reflecting the structure information of the training documents;
a training document keyword extracting step of extracting a keyword at each document content comprised in the “n” number of semantic tags; and
an index list generating step of generating “n” number of index lists corresponding to the “n” number of semantic tags, depending on the keyword.

3. The method of claim 2, wherein the “n” equals to 4 to 8.

4. The method of claim 1, wherein the document retrieval step comprises:
an input document re-organizing step of re-organizing content of the input document depending on the “n” number of semantic tags;
an input document keyword extracting step of extracting the keywords at each document content comprised in the “n” number of semantic tags;
a search query generating step of generating “n” number of search queries corresponding to the “n” number of semantic tags, depending on the keywords; and
a similar document list generating step of comparing the “n” number of index lists with the “n” number of search queries, and generating a list of the similar document similar with the input document.

5. The method of claim 4, wherein the search query generating step extends a range of vocabularies comprised in the “n” number of search queries, using a synonym dictionary.

6. The method of claim 4, wherein the similar document list generating step compares the “n” number of index lists with the “n” number of search queries on a per-same semantic tag basis, and generates the list of the similar document similar with the input document

7. The method of claim 4, wherein the similar document list generating step cross-compares the “n” number of index lists with the “n” number of search queries at each of the “n” number of semantic tags, and generates the list of the similar document similar with the input document.

8. The method of claim 6, wherein the similar document list generating step provides a weight value proportional to a frequency of use of a vocabulary comprised in the “n” number of search queries, and determines a similarity score and a search rank of the similar document comprised in the similar document list.

9. The method of claim 7, wherein the similar document list generating step provides a weight value proportional to a frequency of use of a vocabulary comprised in the “n” number of search queries, and determines a similarity score and a search rank of the similar document comprised in the similar document list.

10. The method of claim 8, wherein the classification code generating step calculates a score on a per-classification code basis of the input document depending on the similarity score and the search rank of the similar document determined in the similar document list generating step, and generates a classification code list of the input document.

11. The method of claim 9, wherein the classification code generating step calculates a score on a per-classification code basis of the input document depending on the similarity score and the search rank of the similar document determined in the similar document list generating step, and generates a classification code list of the input document.

12. A computer readable record medium for recording a program for executing, by a computer, a document classification method for providing a classification code to a document and classifying the document, the method comprising:
a document indexing step of re-organizing contents of training documents using structure information of the training documents provided with classification codes, and generating an index list;
a document retrieval step of searching the training documents for similar documents similar with an input document, using the index list; and
a classification code generating step of generating a classification code list of the input document, using the classification codes of the similar documents.
